(19) United States
(12) Patent Application Publication
(10) Pub. No.: US 2023/0288286 A1
(43) Pub. Date: Sep. 14, 2023

(54) METHOD FOR RECOGNIZING MISALIGNMENTS AND/OR CONTAMINATIONS OF OPTICAL SYSTEMS IN SMART GLASSES, AND OPTICAL SYSTEM

(71) Applicant: Robert Bosch GmbH, Stuttgart (DE)

(72) Inventors: Johannes Fischer, Pliezhausen (DE); Johannes Meyer, Magstadt (DE)

(21) Appl. No.: 18/177,639

(22) Filed: Mar. 2, 2023

(30) Foreign Application Priority Data
Mar. 10, 2022 (DE) 10 2022 202 411.7

(51) Int. Cl. G01M 11/00; G01M 11/02

(52) U.S. Cl. CPC G01M 11/005; G01M 11/0271; G01M 11/0278; G01M 11/0221

(57) ABSTRACT

A method for recognizing misalignments and/or contaminations of optical systems in smart glasses, including at least one laser projector, which is provided for the purpose of outputting at least one light signal forming at least partially an image display of the smart glasses. It is provided that in at least one monitoring step, an at least partial back-reflection of the light signal generated by components of the optical system is detected and examined for deviations from a reference state.

### CROSS REFERENCE

The present application claims the benefit under 35 U.S.C. § 119 of German Patent Application No. DE 10 2022 202 411.7 filed on Mar. 10, 2022, which is expressly incorporated herein by reference in its entirety.

### FIELD

A method for recognizing misalignments and/or contaminations of optical systems in smart glasses, including at least one laser projector, which is provided for the purpose of outputting at least one light signal forming at least partially an image display of the smart glasses has already been provided. For this purpose, smart glasses-external reference systems are generally used in the manufacture of the optical systems.

### SUMMARY

The present invention is directed to a method for recognizing misalignments and/or contaminations of optical systems in smart glasses, including at least one laser projector, which is provided for the purpose of outputting at least one light signal, in particular, a scanned laser signal, forming at least partially an image display of the smart glasses.

According to an example embodiment of the present invention, it is provided that in at least one monitoring step, an at least partial back-reflection of the light signal, in particular, of the scanned laser signal generated by components of the optical system is detected and examined for deviations with a/from a reference state. As a result, a particularly high image output quality of the smart glasses may be ensured. This may advantageously enable, in particular, software-controlled readjustments of optical systems of smart glasses. A long service life for smart glasses may be advantageously achieved. It is advantageously possible for the smart glasses themselves to ascertain damage and/or a need for maintenance/repair. “Misalignment of an optical system” is understood to mean, in particular, a maladjustment of at least one optical element of the optical system. The misalignment of the optical system to be recognized may be caused by an at least partial retraction and/or bending, in particular, of a frame temple that accommodates the laser projector of the smart glasses relative to an eyeglass lens of the smart glasses that includes, in particular, the component of the eyeglass lens. A contamination of the optical system may be caused, in particular, by hair or by particles penetrating the optical system. In the worst case, such a contamination may result in an interruption of an optical path of the optical system. An optical system is understood, in particular, to mean an arrangement of at least two or more components, in particular, optical elements, for example, projectors, reflectors, diffractors, detectors, etc. The components of the optical system may be designed, in particular, partly as optical components (see above, also MEMS mirrors, holographic optical elements, HOEs, diffractive optical elements, DOEs, lenses, etc.), but also as non-optical components such as, for example, carriers for optical components, actuators for optical components, support elements for optical components, etc.

“Smart glasses” are understood, in particular, to mean a wearable (head-mounted) display, with the aid of which pieces of information about the field of vision of a user may be added. Smart glasses preferably allow for augmented reality and/or mixed reality applications. Data glasses are generally also referred to as smart glasses. According to an example embodiment of the present invention, the smart glasses include, in particular, a virtual retina display (Retinal Scan Display). The laser projector is designed, in particular, for the purpose of outputting a scanned laser signal for generating the image display, in particular, the virtual retinal display. The light signal output by the laser projector may include, in particular, a further signal portion, which is invisible to a human eye and/or which is provided for tasks other than the image display. For example, this further signal portion may be designed as an infrared signal, in particular, as an infrared laser signal. Reference states of back-reflections of optical elements/optical system components are, in particular, ascertained and/or recorded during a start-up and/or during a manufacturing of the optical system. Alternatively or in addition, it is possible that reference states are updated regularly during the operation of the smart glasses in order, for example, to be able to correct for small harmless changes, for example, as a result of aging or drifts. In the monitoring step, a setting state of the components of the optical system, in particular, is monitored. In the monitoring step, a degree of contamination of the components of the optical system and/or of the entire optical system, in particular, is monitored. The partial back-reflections of the light signal may be formed from only very small fractions (for example, smaller than 10%, smaller than 1% or even smaller than 0.1%) of the entire emitted light. A misalignment may have been caused, for example, by an external influence on the optical system, such as a fall, a bending, a shock, a partial retraction and/or bending of a hinge of the frame temple. The smart glasses and/or the optical system is/are advantageously able via the method provided to detect such misalignments and/or contaminations, autonomously, automatically, and/or free of external reference systems. Ideally, a rapid, if necessary automatic, corrective action is advantageously made possible as a result. A “misalignment” of individual components is also understood to mean, in particular, a damaging of the individual components.

According to an example embodiment of the present invention, it is further provided that misalignments of the optical system are ascertained by a monitoring of a drop, an increase and/or a change of at least one characteristic signal portion of a back-reflection of the light signal. This may advantageously enable a reliable and/or timely detection of misalignments of the optical system. The characteristic signal portion may be formed, for example, as one particular part of the light spectrum emitted by the laser projector, for example, as particular wavelengths or wavelength bands. For example, the characteristic signal portion may be formed as a part of a signal portion originating from an infrared laser diode of the laser projector.

According to an example embodiment of the present invention, it is also provided that different characteristic signal portions, in particular, of the radiated light spectrum, are back-reflected by different misaligned components of the optical system. As a result, it is possible to reliably ascertain an origin of the misalignment and/or an error source of the optical system. As a result, it is possible to simplify significantly a repair and/or maintenance of the optical system. The different components of the optical system are designed, in particular, in such a way that, provided with such reflection surfaces and/or reflection structures, in particular, a conclusion may be clearly drawn about the identity of the optical element/of the component of the optical system from a back-reflection of every optical element.

According to an example embodiment of the present invention, it is also provided that the characteristic signal portion(s) of the back-reflection light signal is/are characteristic for one particular surface material/surface structure each provided specifically for this recognition. This may advantageously enable an unambiguous assignment of the back-reflection signal to particular surfaces, which in turn may be assigned to particular optical elements/components of the optical system. For example, the back-reflection surfaces of the surface materials of the different optical elements/of the different components of the optical system may have different degrees of coarseness, different structures, different refraction indices, different reflection properties, and/or different absorption properties.

According to an example embodiment of the present invention, it is further provided that the surface material/surface structure provided specifically for recognizing the misalignments is/are situated exclusively in one or in multiple border areas of one or of multiple of the components of the optical system. As a result, it is advantageously possible to minimize or even fully exclude an interference signal and/or an error signal during an optimal adjustment of the optical system. After a maladjustment and/or after a bending, in particular, the light beam passing the optical system strikes border areas of one or of multiple (maladjusted) components/optical elements of the optical system and generates as a result the characteristic signal used for recognizing the misalignment. It is also possible that a degree of reflection of the surface material/surface structure provided specifically for recognizing the misalignments is adapted as a function of a distance/of a path length of the incident light. For example, the degree of reflection is increased as a function of the distance/of the path length. As a result, it is possible to further specify an unambiguous recognition of particular components of the optical system.

According to an example embodiment of the present invention, it is also provided that the characteristic surface material is formed by a retroreflector, in particular, by a retro-reflecting coating, which is optimized, in particular, for a selected detection wavelength range and/or which has unambiguous characteristic return-beam properties. This may advantageously enable an unambiguous assignment of the back-reflection signal to particular surfaces, which in turn may be assigned to particular optical elements/components of the optical system. In addition, a sufficiently strong back-reflection signal may be advantageously obtained, in particular, by the use of a retroreflector. A high sensitivity may be advantageously achieved, in particular, also already for recognizing very small misalignments. A retroreflector is provided, in particular, for the purpose of reflecting an incident electromagnetic radiation largely independent of the direction of incidence back in the direction from which it came. “Provided” is understood to mean, in particular, specifically programmed, designed and/or fitted. An object being provided for a particular function is understood to mean, in particular, that the object fulfills and/or carries out this particular function in at least one application state and/or operating state.

In addition, according to an example embodiment of the present invention, it is provided that misalignments of the optical system are ascertained by a monitoring of a change of a self-mixing interferometry signal (SMI signal) of the laser projector. This may advantageously enable a recognition of misalignments and/or of damages also without an additional processing of the components of the optical system, such as a coating of border areas. A cost efficiency may be advantageously achieved. With the aid of the SMI signal, the monitoring allows, in particular, for an optical fingerprinting of the components of the optical system, in particular, a recognition and/or monitoring of optical fingerprints of the components of the optical system. A comparison with a reference state designed as a factory condition (“good condition”) is, in particular, carried out by the SMI signal during the monitoring of the change of the optical system. A sufficiently large deviation then suggests a maladjustment/misalignment. It is also possible during the monitoring of the SMI signal, in particular, to draw conclusions about misalignments, contaminations and/or damages of the components by detecting a speckle distance of a speckle pattern generated by the irradiated (infrared) laser light on one of the components of the optical system. For example, a recognition of a false incident angle at a holographic optical element (HOE) generated by a bending of the smart glasses may thereby take place. A breakage of an optical element of the optical system may be recognized by a sudden change of a measured distance (strong signal at exactly the distance at which something in the optical system is broken). An optical density of optical elements such as HOEs, in particular, may also be deduced with the aid of the monitoring of the SMI signal. This may advantageously enable a timely detection of temperature changes. For example, the smart glasses could thus warn against an overheating or an undercooling, in particular, still before critical temperatures are reached. An SMI signal is understood, in particular, to mean a measured signal generated by a self-mixing interferometry method. The self-mixing interferometry method is, in particular, an interferometric method, in which a part of a light reflected by a (vibrating) target is back-reflected in a laser resonator of a laser (here, of the laser of the laser projector), which causes, in particular, a modulation both of an amplitude as well as of a frequency of the light signal emitted by the laser (here, the laser projector). In this way, the laser of the laser projector becomes advantageously sensitive to a distance traveled by the reflected beam and thus becomes a distance sensor, velocity sensor, vibration sensor and/or optical fingerprint sensor.

According to an example embodiment of the present invention, it is also provided that contaminations are ascertained by a monitoring of a change of speckle properties, in particular, of a speckle distribution, preferably of a speckle distance, in the back-reflection of the light signal. Thus, a simple and/or reliable contamination monitoring may be advantageously achieved. For example, the speckle properties change when a hair is introduced into an optical path of the speckle-generating laser to the effect that an increased, in particular, especially high, signal intensity (significant backscattering) is detected. A breakage or a misalignment (tilting/shifting) also results in changes in the speckle properties, in particular, in the speckle distribution, which may then be evaluated from the back-reflected signal.

Furthermore, an optical system, in particular, in smart glasses, is provided according to an example embodiment of the present invention, including the laser projector, which is designed for the purpose of outputting the light signal forming at least partially the image display of the smart glasses, including at least one detector for detecting a back-reflection of the light signal, including an evaluation unit for evaluating the measured signals received by the detector, and including at least one component, in particular an optical element, situated in the path of the light signal, the evaluation unit being provided for the purpose of recognizing a misalignment and/or a contamination of the optical system based on an at least partial back-reflection of the light signal generated by the component, in particular, by the optical element. The evaluation unit includes, in particular, at least one processor and one memory, as well as an evaluation program, which may be called up by the processor and which may be stored on the memory. Alternatively, functions of the evaluation may also be relocated in part into a cloud. Preferably, however, the evaluation unit is integrated at least partially into the smart glasses. The evaluation unit is provided, in particular, for the purpose of outputting an evaluation signal. This may take place either via the virtual retina display of the smart glasses themselves or via a display unit designed separately and/or differently from the virtual retina display. The evaluation unit is provided, in particular, for the purpose of comparing instantaneous measured signals of the detector with reference signals corresponding to the reference states. The evaluation unit is provided, in particular, for the purpose of evaluating and/or analyzing speckle properties of the measured signals, in particular, for recognizing misalignment and/or contaminations. The detector is designed, in particular, as a photodetector, preferably as an infrared photodetector.

It is also provided according to an example embodiment of the present invention, that the component, in particular the optical element, is designed as a mirror, in particular as a MEMS mirror of the laser projector, as a part of an eyeglass lens of smart glasses, in particular as a diffractive-optical element (DOE), preferably HOE, integrated in the eyeglass lens, or as an optical lens. This may advantageously enable a misalignment and/or contamination of a plurality of different optical components of the optical system.

If the component, in particular, the optical element, is provided, in particular, coated in one or in multiple border areas with a surface material and/or surface pattern generating a characteristic reflection or a characteristic diffraction, it is advantageously possible to minimize or even fully exclude an interference signal and/or an error signal during an optimal adjustment of the optical system. It is possible that surface materials and/or surface patterns are provided with different characteristic reflections or diffractions in different, for example border, areas situated opposite and/or perpendicularly to one another. In this way, it is possible to ascertain a direction of a misalignment of the components. An arbitrary reflecting surface or surface coating may be used for generating the backscattered light. It would be possible, for example, to coat edges of mirrors (MEMS mirrors) or edges of other components with a retroreflector. This coating could, for example, include glass beads, which are situated in a distributed manner on the surface to be coated. Different densities of the glass bead distribution could then generate different signals, for example, different speckle distributions or different intensities. Furthermore, non-optical elements of the optical system such as, for example springs and/or axes at which the optical elements such as MEMS mirror are mounted and/or suspended, may also be provided, in particular, coated with the surface material and/or surface pattern generating the characteristic reflection or the characteristic diffraction, in particular, with the retroreflector material. These non-optical elements are not actually located in a path of the light beam of the laser projector. In the case of a misalignment or damage, the result may now be that these non-optical elements do intersect the path of the light beam of the laser projector and return a measured signal, which then allows a detection of the misalignment or damage, for example, via the comparison with the reference or with the previous state. A characteristic reflection would, in particular, enable a detection of the misalignments and/or contaminations via a relatively increasing measured signal. A characteristic diffraction would, in particular, enable a detection of the misalignments and/or contaminations via a relatively decreasing measured signal. In principle, both technical implementations are possible.

If the component is provided with a retroreflector generating a characteristic reflection, in particular, with a retro-reflected coating, an unambiguous assignment of the back-reflection signal to particular surfaces may be enabled, which in turn may be assigned to particular optical elements/components of the optical system. In addition, a sufficiently strong return-beam signal may be advantageously obtained, in particular, by the use of a retroreflector.

According to an example embodiment of the present invention, a simple differentiation/selection of the component affected by the misalignment and/or contamination may be advantageously achieved if the optical system also includes a further component, in particular, a further optical component, which is provided with a retroreflector, in particular a retro-reflecting coating, generating a characteristic reflection or characteristic diffraction, the characteristic reflection generated by the further component differing significantly from the characteristic reflection generated by the component. A particularly targeted countermeasure, for example, via a repair and/or a cleaning of precisely the affected component may be advantageously taken.

According to an example embodiment of the present invention, it is also provided that the laser projector and the detector are combined in a VCESL including an integrated photodiode (ViP). A high compactness and/or a particularly high measuring accuracy may be advantageously achieved as a result. If a misalignment now does occur (for example, due to an external influence), the back-reflected light is able to be detected by the ViP and the component affected may then be mapped on the basis of the signal properties of the back-reflected light. In the case of a breakage of a component, new speckle properties automatically occur, for example, which are then able to be detected.

According to an example embodiment of the present invention, the smart glasses including the optical system are also provided. This may advantageously ensure a particularly high image output quality of the smart glasses.

The method according to the present invention and the optical system according to the present invention are not to be limited here to the above-described application and specific embodiment(s). The method according to the present invention and the optical system according to the present invention may, in particular, include a number of individual elements, components and units as well as method steps that differ from a number cited herein for fulfilling a functionality described herein. In addition, in the case of the value ranges specified in this description, values lying also within the cited limits are to be considered described and arbitrarily usable.

### BRIEF DESCRIPTION OF THE DRAWINGS

Further advantages result from the description of the figures. An exemplary embodiment of the present invention is represented in the figures. The figures and the description contain numerous features in combination. Those skilled in the art will also advantageously consider the features individually and combine them to form meaningful further combinations, in view of the disclosure herein.

FIG. 1 schematically shows a representation of smart glasses including an optical system, according to an example embodiment of the present invention.

FIG. 2 schematically shows a representation of the optical system including multiple components, according to an example embodiment of the present invention.

FIG. 3A schematically shows a representation of a component of the optical system designed as a diffractive optical element, according to an example embodiment of the present invention.

FIG. 3B schematically shows a representation of a component of the optical system designed as a vertical MEMS mirror, according to an example embodiment of the present invention.

FIG. 3C schematically shows a representation of a component of the optical system designed as a horizontal MEMS mirror, according to an example embodiment of the present invention.

FIG. 4 schematically shows a flowchart of a method for recognizing misalignments and/or contaminations of the optical systems in smart glasses, according to an example embodiment of the present invention.

### DETAILED DESCRIPTION OF EXAMPLE EMBODIMENTS

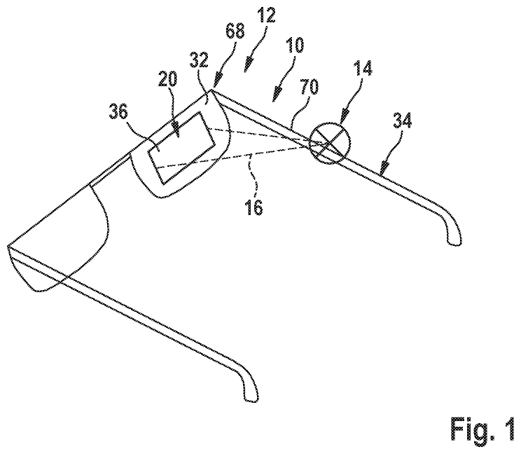

FIG. 1 schematically shows a representation of smart glasses 12. Smart glasses 12 include a virtual retinal display. Smart glasses 12 include an eyeglass frame 34. Smart glasses 12 include eyeglass lenses 32. Eyeglass frame 34 includes a hinge 68. A frame temple 70 of smart glasses 12 is bendable relative to eyeglass lenses 32 with the aid of hinge 68. Smart glasses 12 include an optical system 10.

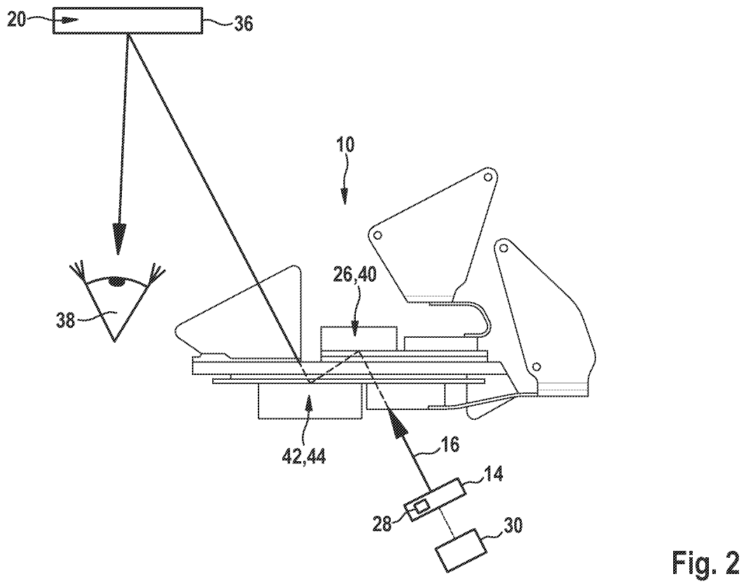

FIG. 2 schematically shows at least one part of optical system 10. Optical system 10 is formed in part by an eyeglass lens 32. Eyeglass lens 32 includes a component 20 of optical system 10. Optical system 10 includes a laser projector 14. Laser projector 14 is designed as a scanned laser projector 14. Laser projector 14 is provided for the purpose of outputting a light signal 16. Light signal 16 generates an image display of smart glasses 12. Light signal 16 may be provided for ascertaining a pupil position, a pupil movement, a pupil shape and/or a pupil size. Laser projector 14 is integrated at least partially into eyeglass frame 34. Laser projector 14 is provided for the purpose of outputting light signal 16 in the form of a scanned laser beam. The scanned laser beam is provided for the purpose of outputting the image display directly onto a retina of an eye 38 of a user. The scanned laser beam output by laser projector 14 includes visible light. The laser beam output by laser projector 14 includes infrared light.

Optical system 10 includes a detector 28. Detector 28 is provided for detecting a back-reflection of light signal 16. Detector 28 in this case may be designed to be sensitive to visible light and/or sensitive to invisible light (for example, infrared light). Detector 28 is situated “on axis” with the laser beam emitted by laser projector 14. Detector 28 is integrated into laser projector 14. Laser projector 14 and detector 28 are combined in a VCESL (vertical-cavity surface-emitting laser) including an integrated photodiode (ViP).

Optical system 10 includes components 20, 26, 44, which are situated in a beam path of the laser beam emitted by laser projector 14. Components 20, 26, 44 are situated in a path of light signal 16. One component 20 of optical system 10 is designed as a diffractive optical element (DOE, 36). DOE 36 is designed preferably as a holographic optical element (HOE). DOE 36 is integrated into one of eyeglass lenses 32 of smart glasses 12. DOE 36 is provided for the purpose of deflecting the scanned laser beam in the direction of an eye 38 of a user. DOE 36 is provided for the purpose of at least partially focusing the scanned laser beam into eye 38 of the user. A further component 26, 44 of optical system 10 is designed, for example, as a MEMS mirror 40, 42 of laser projector 14. Optical system 10 may also include multiple additional further components. Further component 26, 44 could, for example, also be designed as an optical element of optical system 10 having a further optical function, such as a lens or as a non-optical element of optical system 10, such as a mounting for optical elements or an aperture. Optical system 10 includes an evaluation unit 30. Evaluation unit 30 is provided for evaluating the measured signals (back-reflection signals) received by detector 28.

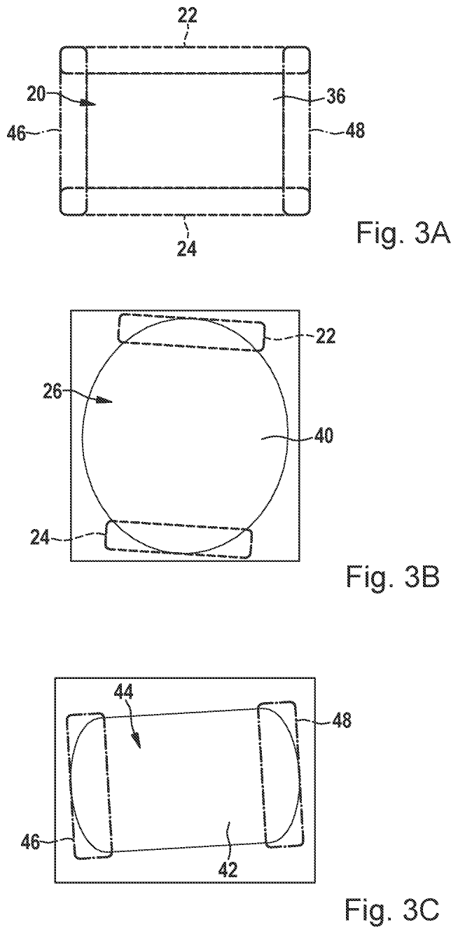

FIGS. 3a through 3c show by way of example three components 20, 26, 44 of optical system 10. FIG. 3a shows a DOE 36. DOE 36 of FIG. 3a is designed as an HOE. FIG. 3b shows a MEMS mirror 40. MEMS mirror 40 of FIG. 3b is designed as a quasi-static vertical mirror of laser projector 14. FIG. 3c shows a further MEMS mirror 42. Further MEMS mirror 42 of FIG. 3c is designed as an oscillating horizontal mirror of laser projector 14. Components 20, 26, 44 of optical system 10 are provided in each case in border areas 22, 24, 46, 48 with a specific surface material and/or with a specific surface pattern. The specific surface material and/or surface pattern generate(s) a characteristic reflection or a characteristic diffraction. The specific surface material and/or surface pattern is/are formed as/by a coating. The specific surface material and/or surface pattern act(s) retro-reflectively. The specific surface material and/or surface pattern is/are formed by a retroreflector. The specific surface material and/or surface pattern is/are formed by a retro-reflecting coating. The characteristic reflections/diffractions generated by respective different components 20, 26, 44 differ significantly from one another. The reflections/diffractions generated by respective different border areas 22, 24, 46, 48 differ significantly from one another. Upper horizontal border area 22 of DOE 36 shown in FIG. 3a exhibits by way of example a first characteristic reflection. Lower horizontal border area 24 of DOE 36 shown in FIG. 3a exhibits by way of example a second characteristic reflection. Left vertical 46 of border area 24 of DOE 36 shown in FIG. 3a exhibits by way of example a third characteristic reflection. Right vertical 48 border area 24 of DOE 36 shown in FIG. 3a exhibits by way of example a fourth characteristic reflection. Border areas 22, 24, 46, 48 are situated around component 20. Border areas 22, 24, 46, 48 in the exemplary embodiment of FIG. 3a do not overlap component 20. In the exemplary embodiments of FIGS. 3b and 3c, border areas 22, 24, 46, 48, however, overlap respective components 26, 44. All of these characteristic reflections of border areas 22, 24, 46, 48 in this example are different and are able to be identified by detector 28 and/or by evaluation unit 30. As a result of the difference in the characteristic reflections, it is possible to ascertain a source of a back-reflection signal detected by detector 28.

Evaluation unit 30 is provided for the purpose of recognizing a misalignment of optical system 10 based on the at least partial back-reflections of light signal 16 generated by respective components 20, 26, 44. Evaluation unit 30 is provided for the purpose of recognizing a setting of hinge 68 of smart glasses 12 based on the at least partial back-reflections of light signal 16 generated by respective components 20, 26, 44. Evaluation unit 30 is provided for the purpose of recognizing a contamination of optical system 10 based on the at least partial back-reflections of light signal 16 generated by respective components 20, 26, 44. Evaluation unit 30 is provided for the purpose of recognizing a damage to optical system 10 such as, for example, a breakage of one of components 20, 26, 44 of optical system 10 based on the at least partial back-reflections of light signal 16 generated by respective components 20, 26, 44.

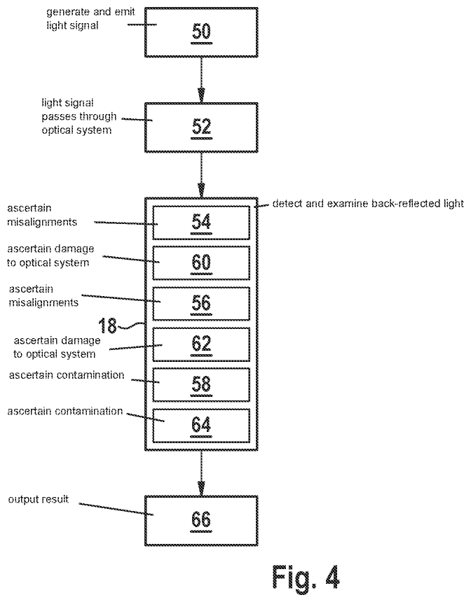

FIG. 4 schematically shows a flowchart of a method for recognizing misalignments and/or contaminations of optical systems 10 in smart glasses 12. In at least one method step 50, light signal 16 is generated and emitted by laser projector 14. In at least one further method step 52, light signal 16 passes optical system 10. When passing optical system 10 (misaligned or aligned), a portion of light signal 16 is back-reflected by components 20, 26, 44 of optical system 10. If a contamination of optical system 10 is now present, the contamination produces a deviation of the back-reflected signal compared to an uncontaminated reference state. If a misalignment of optical system 10 is now present, emitted light signal 16 strikes border areas 22, 24, 46, 48 of components 20, 26, 44 of optical system 10, from where it is back-reflected to detector 28. In the process, different characteristic signal portions are back-reflected by different border areas 22, 24, 46, 48 of misaligned components 20, 26, 44 of optical system 10. In this case, the characteristic signal portions of the back-reflection light signal are characteristic in each case for one particular surface material provided specifically for this recognition. In this case, the surface materials and/or surface patterns may be optimized specifically for particular selected detection wavelength ranges and/or include unambiguous characteristic return-beam properties. To increase the signal, the respective surface materials emitting the characteristic signal portions are formed by a retroreflector, such as a retro-reflecting coating. To simplify the signal evaluation and/or the distinguishability of different back-reflected signals, the surface materials emitting the characteristic signal portions are designed in such a way that they generate (in each case, different) speckle patterns in the reflection of collimated laser light.

In at least one monitoring step 18, the back-reflection of light signal 16 generated by components 20, 26, 44 of optical system 10 is detected and examined for deviations using the respective reference state of optical system 10 (border area reflections) and/or the respective optical components 20, 26, 44 (SMI method). In monitoring step 18, the back-reflection is detected by detector 28 as a measured signal. In monitoring step 18, the detected measured signal is evaluated and/or analyzed by evaluation unit 30. In at least one sub-step 54 of monitoring step 18, misalignments of optical system 10 are ascertained by a monitoring of an increase and/or a change in at least one signal portion of a back-reflection of light signal 16 characteristic for border areas 22, 24, 46, 48. In at least one further sub-step 60 of monitoring step 18, damages to optical system 10, such as breakages of optical components 20, 26, 44 of optical system 10, are ascertained by a monitoring of an increase and/or a change in at least one characteristic signal portion of a back-reflection of light signal 16 characteristic for border areas 22, 24, 46, 48. In at least one further sub-step 56 of monitoring step 18, misalignments of optical system 10 are ascertained by a monitoring of a change of a self-mixing interferometry signal (SMI signal) of laser projector 14. In at least one further sub-step 62 of monitoring step 18, damages to optical system 10, such as breakages of optical components 20, 26, 44 of optical system 10, are ascertained by a monitoring of a change in the SMI signal of laser projector 14. In at least one further sub-step 58 of monitoring step 18, contaminations of optical system 10 are ascertained by a monitoring of a change in the speckle properties in the back-reflection of light signal 16. In at least one further sub-step 64 of monitoring step 18, contaminations of optical system 10 are ascertained by a monitoring of a change in the SMI signal of laser projector 14. In at least one further method step 66, the result of monitoring step 18 is output to the user.

What is claimed is:

1. A method for recognizing misalignments and/or contaminations of optical systems in smart glasses, the smart glasses including at least one laser projector which is configured to output at least one light signal forming at least partially an image display of the smart glasses, the method comprising:
detecting, in at least one monitoring step, an at least partial back-reflection of the light signal generated by components of the optical system; and
examining the back-reflection for deviations from a reference state.

2. The method as recited in claim 1, further comprising:
ascertaining misalignments of the optical system by monitoring an increase and/or a change in at least one characteristic signal portion of the back-reflection of the light signal.

3. The method as recited in claim 2, wherein different characteristic signal portions are back-reflected by different misaligned components of the optical system.

4. The method as recited in claim 2, wherein the characteristic signal portions of the back-reflection light signal is characteristic in each case for one particular surface material/surface structure provided specifically for recognition of the misalignments.

5. The method as recited in claim 4, wherein the surface material/surface structure provided specifically for the recognition is/are situated exclusively in one or in multiple border areas of one or of multiple of the components of the optical system.

6. The method as recited in claim 4, wherein the surface material/surface structure is formed by a retroreflector by a retro-reflecting coating, which is optimized for a selected detection wavelength range and/or which includes unambiguous characteristic return-beam properties.

7. The method as recited in claim 1, further comprising:
ascertaining misalignments of the optical system by a monitoring of a change in a self-mixing interferometry signal of the laser projector.

8. The method as recited in claim 1, further comprising:
ascertaining contaminations by monitoring a change in speckle properties in the back-reflection of the light signal.

9. An optical system in smart glasses, comprising:
at least one laser projector configured to output at least one light signal forming at least partially an image display of the smart glasses;
at least one detector configured to detect a back-reflection of the light signal;
an evaluation unit configured to evaluate back-reflected light signals received by the detector; and
at least one component situated in a path of the light signal;
wherein the evaluation unit is configured to recognize a misalignment and/or a contamination of the optical system based on an at least partial back-reflection of the light signal generated by one of the at least one of the components.

10. The optical system as recited in claim 9, wherein the component is a MEMS mirror of the laser projector, as a part of an eyeglass lens of the smart glasses, a diffractive optical element being integrated into the eyeglass lens or an optical lens.

11. The optical system as recited in claim 9, wherein the component is coated, in one or in multiple border areas with a surface material and/or surface pattern generating a characteristic reflection or a characteristic diffraction.

12. The optical system as recited in claim 9, wherein the component includes a retroreflector configured to generate a characteristic reflection with a retro-reflecting coating.

13. The optical system as recited in claim 12, further comprising:
a further component provided with a further retroreflector, the further retroreflector including a retro-reflecting coating configured to generate a characteristic reflection or a characteristic diffraction, the characteristic reflection generated by the further component differing significantly from the characteristic reflection generated by the component.

14. The optical system as recited in claim 9, wherein the laser projector and the detector are combined in a VCESL including an integrated photodiode.
